(19) United States
(12) Patent Application Publication
(10) Pub. No.: US 2016/0323550 A1
(43) Pub. Date: Nov. 3, 2016

(54) SCANNED LIGHT BEAM VIDEO PROJECTION SYSTEM AND METHOD, AUTOMOTIVE VEHICLE HEAD-UP DISPLAY AND ADAPTIVE LIGHTING DEVICE USING SUCH A SYSTEM

(71) Applicant: VALEO COMFORT AND DRIVING ASSISTANCE, Creteil (FR)

(72) Inventor: Michael Irzyk, Creteil (FR)

(73) Assignee: VALEO COMFORT AND DRIVING ASSISTANCE, Creteil (FR)

(21) Appl. No.: 15/108,677

(22) PCT Filed: Dec. 18, 2014
(86) PCT No.: PCT/FR2014/000295

§ 371 Date: Jun. 28, 2016

(30) Foreign Application Priority Data
Dec. 30, 2013 (FR) 1363697

(51) Int. Cl. H04N 9/31; G02B 27/12; G02B 27/01; G02B 27/10; G02B 27/28; G03B 21/20

(52) U.S. Cl. CPC H04N 9/3164; H04N 9/3129; H04N 9/317; H04N 9/3161; G02B 27/283; G03B 21/2013; G03B 21/204; G03B 21/2073; G02B 27/0101; G02B 27/104; G02B 27/126

(57) ABSTRACT

The invention relates to a scanned light beam video projection system. The system is characterised in that it comprises a device (1) for emitting a light beam (18) modulated by a video signal, and scanning means (20) able to deviate said light beam (18) in order to allow a video image (22) to be formed, the emitting device (1) comprising at least two separate light sources (24, 25) each emitting a light sub-beans (14, 15) of different substantially rectilinear polarisation to the other, and a recombining device (12) configured to form said light beam (18) by adding the two light sub-brams (14, 15), in the direction of the scanning means (20).

### 1. TECHNICAL FIELD OF THE INVENTION

The invention relates to a scanned light beam video projection system.

The invention can, for example, be used in a projection or imaging apparatus, wherein a light source produces a light beam which is associated with scanning means in order to form an image, for example on a head-up display. The light source of such a head-up display generally comes from one or more laser sources modulated by a video signal representing the image to be displayed.

The invention can also be used for an automotive vehicle adaptive lighting device, using scanning means forming an image on a wavelength converting device, emitting, in turn, a lighting light beam modulated according to said image.

The various uses of the apparatuses using a scanning projection system require the use of light beams having increasingly great optical power in order to improve the performance thereof, and therefore light sources of greater power. Yet, and particularly in a small scanning projection system, the use of a source having excessive power causes excessive heat dissipation problems which can, in turn, lead to deterioration of the source itself or of the neighboring components. Such small projection systems are, for example, on-board systems, particularly in a vehicle for a so-called head-up display. The problem is all the more great as the system uses multicolored sources in order to form a polychromatic beam such as to project a color image. In the context of a conventional polychromatic system using three red, green and blue beams, it is necessary to use three light sources which further increases the heat dissipation problems.

In addition to the problems relating to the heat dissipation, the light sources available on the market which are suitable for the constraints of the scanning systems have a reduced power. Furthermore, the current solutions which allow the power of these sources to be increased cannot be used in a scanning system, particularly as regards beam size problems. Indeed, the scanning means are produced, for example, in the form of a MEMS micromirror or an array of such micromirrors, which require a beam of suitable size.

### 2. AIMS OF THE INVENTION

An aim of the invention is to overcome at least some of the disadvantages of the known scanned light beam video projection systems.

Another aim of the invention is to provide a scanning video projection system allowing the power of the light beam to be increased without causing a heat dissipation problem.

Another aim of the invention is to provide a scanning video projection system allowing the power of the light beam to be increased without substantial modification of the size of the light beam.

### 3. DISCLOSURE OF THE INVENTION

To this end, the invention relates to a scanned light beam video projection system, characterized in that it comprises a device for emitting a light beam modulated by a video signal, and scanning means suitable for deflecting said light beam in order to allow a video image to be formed, the emitting device comprising at least two separate light sources each emitting a light sub-beam of substantially linear polarization, which polarization is separate from the other, and a recombining device configured to form said light beam by combining the two light sub-beams, in the direction of the scanning means.

Recombining device means a device in which it is possible to input two light beams of different polarization direction such that these light beams are combined at the output of this device in a single light beam combining the polarization directions of the two input beams.

Therefore, the invention allows, by using two light sources rather than a single more powerful source, the heat dissipation problems to be reduced by limiting the power of each source, and by increasing the surface available for the heat dissipation. The combination of the two light sub-beams allows the formation of a light beam, the power of which is equal to adding the powers of the two light sub-beams, while keeping a light beam size suitable for a scanning video projection, by particularly reducing the divergence phenomena.

Advantageously and according to the invention, the recombining device is a recombining prism.

Recombining prism means a prism in which it is possible to input two light beams with different directions of polarization such that these light beams are combined at the output of this prism in a single light beam combining the polarization directions of the two input beams.

Advantageously and according to this last aspect of the invention, the recombining prism is one of the following prisms:
Wollaston prism,
Glan-Taylor prism,
Glan-Thompson prism,
Nicol prism.

According to this aspect of the invention, these prisms which are generally used to divide a light beam polarized in two separate directions into two beams each polarized in one of the two separate directions, are used in this case for an opposite aim, i.e. combining two beams polarized in different directions of polarization in a single light beam polarized in these two directions.

Advantageously and according to the invention, the two light sub-beams have polarizations that are perpendicular to one another.

According to this aspect of the invention, the combination of the two sub-beams is more effective due to the minimum interference between the two light beams when the polarizing directions thereof are perpendicular.

Advantageously and according to the invention, the light sources are laser sources.

According to this aspect of the invention, the light sources are laser sources which are naturally polarized, in order to avoid having to polarize the light sub-beams coming from these light sources before combining them, which can lead to power losses.

Advantageously and according to this last aspect of the invention, the laser sources have power frequency spectrums that are different in a same narrow frequency band.

A narrow frequency band means a frequency band in which the colors of the lasers at the frequencies of this band cannot be differentiated by the human eye. According to this aspect of the invention, the spectrums are different in order to prevent the phenomena of speckles which can appear if the spectrums of the two laser sources are identical, but they remain within a frequency band that is sufficiently narrow such that the two lasers have colors that cannot be differentiated such as to not damage the projected video image.

Advantageously and according to the invention, the light sub-beams are polychromatic sub-beams and the light sources are polychromatic sources.

According to this aspect of the invention, the polychromatic sources allow an image video projection over a large color palette, by combining monochromatic beams. However, in this case, the two light sub-beams must be made up of the same color components in order to allow a beam that has the same color as the two previous sub-beams to be obtained by combination.

Advantageously and according to this last aspect of the invention, each polychromatic light source comprises three monochromatic light sources, a red source emitting a red light beam, a green source emitting a green light beam and a blue source emitting a blue light beam, the red, green and blue beams being combined to form each polychromatic sub-beam.

According to this aspect of the invention, the three red, green and blue sources make up a so-called RGB (Red, Green, Blue) conventional system in order to obtain a large color palette by combining the three monochromatic beams emitted by the monochromatic sources.

The invention also relates to a display, in particular a head-up display, comprising a projection system according to the invention.

Such a display can be used in a vehicle, particularly an automotive vehicle, in order to display the video image projected by the projection system.

The invention also relates to an automotive vehicle adaptive lighting device, comprising a projection system according to the invention.

Advantageously, the lighting device further comprises a wavelength converting device, on which an image is formed by the projection system, the converting device emitting a beam which is thus modulated according to said image.

The invention also relates to a scanned light beam video projection method, characterized in that it comprises a step of emitting a light beam modulated by a video signal, a step of deflecting said light beam by scanning in order to allow the formation of a video image, the step of emitting a light beam being preceded by a step of combining two separate light sub-beams of substantially linear polarization, which polarizations are separate from one another, in order to form said light beam.

Advantageously, the method according to the invention is implemented by the system according to the invention.

Advantageously, the system according to the invention implements the method according to the invention.

### 4. DESCRIPTION OF THE FIGURES

Other aims, features and advantages of the invention will emerge upon reading the following description given in a solely nonlimiting manner and with reference to the appended figures, wherein:

FIG. 1 is a schematic representation of the functioning of a recombining prism of a projection system according to an embodiment of the invention,

FIG. 2 is a schematic representation of a projection system according to an embodiment of the invention,

FIG. 3 is a schematic representation of a polychromatic light source according to an embodiment of the invention,

FIG. 4 is a schematic view of a video projection system and of a head-up display according to an embodiment of the invention,

FIG. 5 is a schematic view of a video projection system and of an adaptive lighting device according to an embodiment of the invention.

### 5. DETAILED DESCRIPTION OF AN EMBODIMENT OF THE INVENTION

It should be noted that the figures disclose the invention in a detailed manner in order to implement the invention, wherein said figures can, of course, be used to better define the invention, where required.

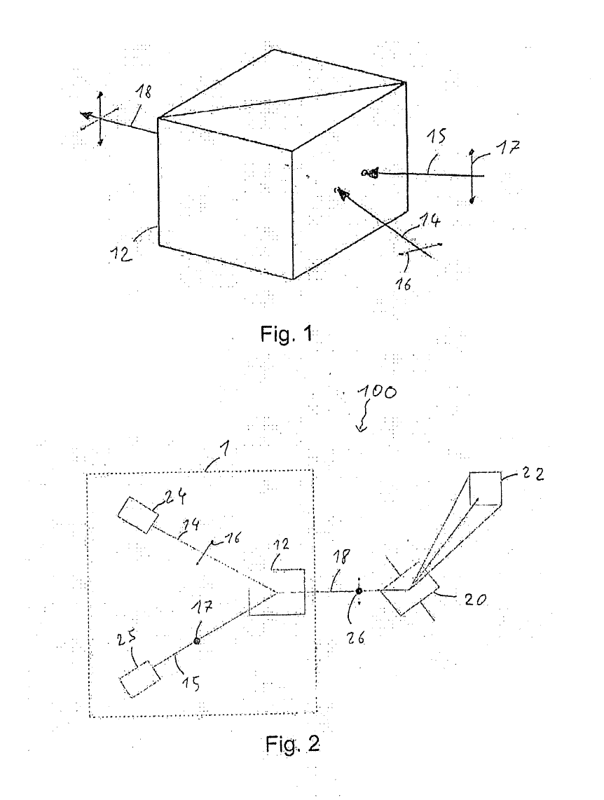

FIG. 1 schematically shows the functioning of a recombining prism 12 which can be used as a recombining device in an embodiment of the video projection system according to the invention. The recombining prism 12 is configured such as to interact differently with the light beams passing therethrough depending on the polarization thereof. Examples of conventional recombining prisms are the Glan-Taylor prisms, Glan-Thompson prisms, Nicol prisms, etc. The prism shown in this case is a Wollaston prism. All of these prisms are generally used to separate an unpolarized light beam into two light beams having perpendicular polarization directions.

In a system according to an embodiment of the invention, the recombining prism 12 is used differently, namely to combine two light sub-beams 14, 15 with perpendicular polarization directions 16, 17 in order to form a light beam 18 combining the two polarization directions of the two sub-beams 14, 15.

FIG. 2 shows a video projection system 100 according to an embodiment of the invention. The projection system 100 comprises a device 1 for emitting a light beam 18 and scanning means 20 which deflect the light beam 18 in order to form a video image 22.

The emitting device 1 comprises two light sources, a first light source 24 emitting a first light sub-beam 14 and a second light source 25 emitting a second light sub-beam 15. The two sub-beams 14, 15 are directed towards a recombining device, in this case the recombining prism 12 described with reference to FIG. 1.

The two sub-beams 14, 15 have different polarization directions, in this case one perpendicular to the other in order to optimize the optical efficiency and reduce the interference between the two sub-beams 14, 15 during the recombination in the prism 12. The first sub-beam 14 has a substantially linear and horizontal polarization direction 16, shown by a double arrow, and the second sub-beam 15 has a substantially linear and vertical polarization direction 17, shown by a dot. At the output of the recombining prism 12, the two sub-beams 14, 15 are merged into a single beam 18, which is polarized in both polarization directions of the two light sub-beams, as shown by the reference 26.

The light sources 24, 25 used are laser sources, typically laser diodes, which advantageously are naturally polarized. As shown in FIG. 2, the directions in which the beams 14, 15 must enter the recombining prism 12 lead to the sources 24, 25 being distanced. This distancing allows for the increase of the heat dissipation surface and therefore for the prevention of the heating of the components due to the optical power necessary for the projection system 100 to project the image 22. Moreover, each source 24, 25 has an optical power equal to half the optical power necessary for projecting the image 22. For example, if the projection of the image 22 under good conditions requires an optical power of 100 mW, each source 24, 25 emits a sub-beam 14, 15 with an optical power of 50 mW, thereby allowing a recombining beam 18 of 100 mW to be obtained.

In an advantageous embodiment, the laser sources 24, 25 have power frequency spectrums that are different in a same narrow frequency band, i.e. a frequency band in which the colors of the lasers at the frequencies of this band cannot be differentiated by the human eye. This allows the prevention of the phenomena of speckles which can appear if the spectrums of the two laser sources are identical, but they remain sufficiently close such that the two lasers have colors that cannot be differentiated such as to not damage the projected video image.

For video image projection requiring a light beam 18 having a broad palette of possible colors, the beam 18 must be a polychromatic beam, i.e. it is made up of a combination of monochromatic beams. A conventional projection system uses a combination of the three beams, a red beam, a green beam and a blue beam, of the RGB (Red, Green, Blue) type. In a projection system according to this embodiment of the invention, each light source 24, 25 is therefore a polychromatic source which comprises several monochromatic light sources, in this case three monochromatic sources, a red source emitting a red beam, a green source emitting a green beam and a blue source emitting a blue beam. These three red, green and blue beams are combined to form the polychromatic sub-beams.

As a result of the presence of these multiple monochromatic light sources in order to form each sub-beam, the improvement in the heat dissipation brought by the invention is all the more necessary for the proper operation of the projection system 100.

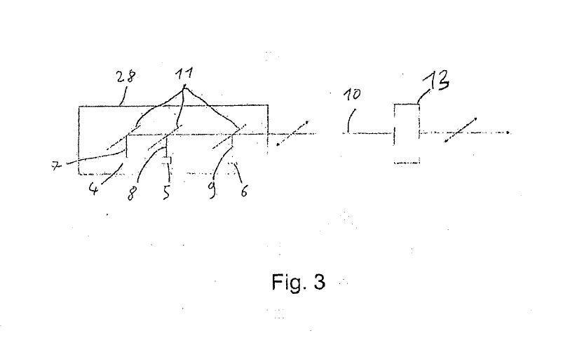

FIG. 3 illustrates in greater detail the operation of one of the polychromatic light sources.

The polychromatic light source 28 comprises one or more monochromatic light sources 4, 5, 6 each emitting a laser beam 7, 8, 9. These are, for example, laser sources, typically laser diodes, each laser source emitting a monochromatic beam, i.e. consisting of a single color. In an embodiment of the invention, this polychromatic source 28 is therefore used to form each of the light sources 24 and 25.

The polychromatic source 28 comprises, in this case, three monochromatic sources 4, 5, 6, said device being configured to form a polychromatic light beam 10 via pooling by combining the monochromatic beams 7, 8, 9 individually emitted by each of the sources 4, 5, 6. More precisely, these can be monochromatic sources emitting a beam having a color that is different from one source to the other, for example, a red beam, a green beam or a blue beam (RGB), emitted by a red diode, a green diode or a blue diode, respectively.

The optical power of each of the monochromatic sources is controlled, independently, using the supply current of the laser source/sources. At a given optical power, the color of the polychromatic beam 10 is determined by the manner in which the power ratio is established between the various laser diodes. For example, to obtain a white light, the optical powers, proportionately, must be established using the following distribution: 60% for the green diode, 30% for the blue diode, 10% for the red diode. As expanded upon below, the optical power of each of the monochromatic sources can also be controlled to modulate the optical power of the polychromatic beam 10.

The beams 7, 8, 9 emitted by each of the monochromatic sources are oriented, for example, in parallel with each other and reflected in a same direction in order to form, by combination, the joint polychromatic beam 10. In this case, the polychromatic source comprises, in this respect, optical elements that are semitransparent, over a wavelength range, such as dichroic mirrors or combining blades 11, intercepting the monochromatic beams 7, 8, 9 emitted by each of the monochromatic sources and combining them in the direction of the polychromatic beam 10.

More generally, the polychromatic source 28 is configured to form the polychromatic beam 10 from the monochromatic laser beam/beams 7, 8, 9 regardless of the number of monochromatic sources 4, 5, 6 in question. In the case of a single monochromatic source, the beam 10 is made up of the laser beam emitted by the single source used and the image obtained will then be monochrome, made up of the various levels of optical powers used for each of the dots which make it up, according to a gradation of said color. In the case of a plurality of monochromatic sources, typically the three sources 4, 5, 6 stated above, the joint beam 10 which then forms the polychromatic beam will allow an image to be established according to a color spectrum, the resolution of which will correspond to the fineness of controlling the power supply of said monochromatic sources 4, 5, 6.

In an embodiment, the video projection system also comprises attenuation means 13, located downstream of the source/sources 4, 5, 6, allowing the optical power of the light beam 10 to be varied. In other words, since a color and/or an intensity are/is given to the polychromatic beam 10 by the control of the supply of current to the monochromatic sources, the attenuation means 13 allow the optical power of the beam/beams 7, 8, 9, 10 to be varied. It will be possible, in particular, to adjust the optical power of the beam to daytime driving conditions and nighttime driving conditions, for use of the system in an automotive vehicle head-up display.

The polychromatic source 28 can comprise means of controlling the supply of current to the monochromatic sources. As stated above, they can allow the color of the beam 10 to be chosen.

More precisely, the control means are configured, for example, to provide current linear regulation for the optical power of the monochromatic laser beams 7, 8, 9 in order to provide the choice of color of the polychromatic beam 10, according to an optical power proportion allocated to each of the monochromatic laser beams 7, 8, 9. It will be possible, for example, to provide six bit color coding, corresponding to 64 levels of optical power for each of said monochromatic laser beams 7, 8, 9.

The control means can also be configured to provide additional setting of the optical power of the light beam. In this manner, it is possible to reach a particularly high attenuation rate.

More precisely, the control means are configured to provide regulation via pulse width modulation of the optical power of the monochromatic laser beams 7, 8, 9 such as to achieve additional setting of the optical power of the polychromatic beam 10, in particular according to an attenuation factor of between 5 and 20, in particular approximately 10.

In this way, it is possible to set the color and/or the optical power of the polychromatic beam 10. The control means comprise, for example, a microcontroller, which is not shown.

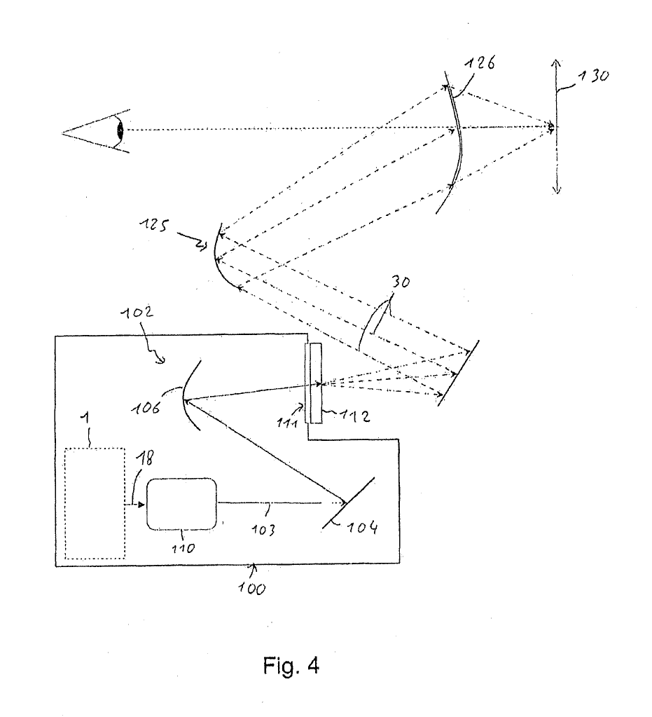

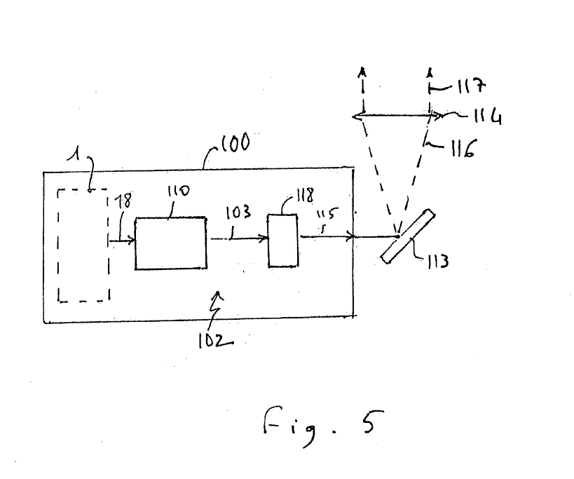

As illustrated in FIG. 4, the invention also relates to a head-up display comprising a video projection system 100 according to the invention. The projection system 100 further comprises means 102 for forming an image from the light beam 18 emitted by the emitting device 1.

The image forming means 102 comprise scanning means such as, for example, a scanning generator 110, the function of which is to horizontally and vertically move the light beam 18 in order to produce a scan according to a given frequency, equal to 60 Hz by way of nonlimiting example. The scanning generator 110 comprises, in particular, a micro-electromechanical system scanning mirror (hereafter called MEMS mirror) on which the light beam 18 is reflected as a scanning beam 103. Such a MEMS mirror has, for example, a diameter of 1 mm². The MEMS mirror is suitable for rotating about two rotational axes in order to produce a scan, for example at the refresh rate of 60 Hz, of a diffusing screen 111 of the means 102 for forming an image. Said image is then formed on the diffuser 111. Alternatively, the MEMS mirror can be replaced with two planar and movable mirrors, the movements of which are linked. One of these mirrors can be dedicated to scanning along a horizontal axis whereas the other mirror can be dedicated to scanning along a vertical axis.

The diffuser 111 at which the image is formed can be a projection transparent screen having a complex structure for rear projection. Alternatively, it can be translucent. It is produced, for example, from glass, particularly depolished or polycarbonate glass. By way of example, the diffusing screen is an exit pupil diffusing screen (“exit pupil expander”). It allows for an enlarged observation cone. It extends in a plane through which the light beam passes, the image resulting from this scanning beam 103 being formed in the plane of a face of the diffusing screen 111.

This diffusing screen receives the scanning beam 103. It is arranged to cause scattering of this scanning beam 103 according to a given angular section, for example equal to 30° with respect to the direction of the scanning beam 103 at the moment when it hits the diffusing screen 111. To this end, according to a nonlimiting example, a face 112 of the diffusing screen is rough, in the sense that it includes bumps which cause the scattering of the scanning beam 103. The rough face 112 corresponds to that through which the beam exits, i.e. the face on which the image is formed.

According to another alternative that is not illustrated, said image forming means do not include a scanning generator, as described above, but an array of micromirrors (also called “digital micromirror systems”). In this configuration, the image is formed at the micromirror array, then projected onto the diffusing screen. Generally, projection optics are placed between the array and the screen. Each micromirror corresponds to a pixel of the image. In this embodiment, the image is not formed on the diffusing screen for the first time, but receives an image previously formed on the micromirror array.

It should be noted that the attenuation means 13 of FIG. 3 can be arranged upstream of the image forming means 102. They can still be downstream. In an alternative, they can be placed between the scanning generator 110 or the micromirror array and the diffusing screen 111.

The projection system can further comprise various planar or concave mirrors 104, 106 such as to focus the beams towards the diffusing screen 111, which mirrors are placed in particular on the path of the scanning beam 103.

The invention further relates to a display, particularly a head-up display, comprising a projection system 100 according to any one of the alternatives detailed above.

Downstream of the diffusing screen 111 in the direction of movement of the light beam, the display comprises at least one semi-reflecting blade 126 and a reflecting device 125 inserted on the route of the image between the diffusing screen 111 and the semi-reflecting blade 126, the reflecting device 125 comprising one or more planar or concave mirrors, as shown in FIG. 4. In this figure, the route of the image is symbolized by three dotted arrows 30 which are reflected on the reflecting device 125 before being displayed through the semi-reflecting blade 126. The latter allows a magnification and/or, by transparency, a display of the image beyond said semi-reflecting blade, particularly beyond the windshield of the equipped vehicle, at a virtual screen 130, obtained using the semi-reflecting blade 126.

This semi-reflecting blade has a reflectivity at least equal to 20%, which allows the user to see, through the blade, the road taken by the vehicle, while benefiting from a high brightness allowing the displayed image to be seen. Alternatively, the image can be displayed at the windshield of the vehicle provided with said display.

As illustrated in FIG. 5, the invention also relates to an automotive vehicle adaptive lighting device, comprising a video projection system 100 according to the invention.

As in FIG. 4, with the same references relating to the same elements, the video projection system 100 comprises the emitting device 1, providing the combined beam 18, and the image forming means 102. The means 102 comprise, in turn, the scanning means 110, providing a scanning beam 103, and optical means referenced 118, of the type of mirrors 104, 106 of FIG. 4, which is intended to focus the scanning beam on the device 113.

The beam output from the optical means 118 has the reference 115.

The element 113 is a wavelength converting device such as, for example, a phosphor plate, or more precisely a plate on which a phosphor continuous and uniform layer has been deposited.

As is known, each point of the plate of the wavelength converting device 113 receiving the beam 115 then reemits a beam 116, illustrated in dotted line, having a different wavelength, and in particular a light which can be considered to be “white”, i.e. which includes a plurality of wavelengths between approximately 400 nanometers and 800 nanometers, i.e. within the visible light spectrum. This light emission occurs as per a Lambertian emission diagram, i.e. with a light intensity that is uniform in all directions.

Preferably, the phosphor is deposited on a substrate that reflects laser radiation. Thus, it is ensured that the laser radiation which would not have hit phosphor grains before having completely passed through the phosphor layer will be able to hit a phosphor grain after having been reflected by the substrate.

Also preferably, the substrate is chosen from good heat conducting materials. Such an arrangement allows the provision of a low phosphor temperature, or at least the prevention of the temperature thereof from becoming excessive. The efficiency, i.e. the phosphor conversion efficiency, is then at a maximum.

Therefore, this ensures a maximum conversion efficiency between the laser radiation and the white light.

Preferably again, the surface of the wavelength converting device is made up of a phosphor continuous and uniform layer. Indeed, the partition of the phosphor plate into separate elements does not allow the desired precision to be obtained in the reemission of white light, particularly at the points located at the boundary between two phosphor elements.

The phosphor plate 113 is located in immediate proximity to the focal plane of an imaging optical system 114, which then forms, at infinity, an image of the phosphor plate 113, or more precisely of the points of this plate which emit white light in response to the luminous excitation received thereby. In other words, the imaging optical system 114 forms a light beam 117, also illustrated by a dotted line, with the light emitted by the various points of the phosphor plate which are illuminated by the radiation 115.

The light beam 117 emerging from the imaging system 114 is therefore a direct function of the light rays 116 emitted by the phosphor plate 113, which themselves are a direct function of the radiation 115 which scans this plate 113.

A control unit (not shown) controls the various components of the system according to the invention as a function of the desired photometry of the light beam 117. In particular, the control unit simultaneously controls:
the scanning means 110 such that the beam 115 successively scans all of the points of the phosphor plate 113, and
the emitting device 1 in order to modulate the intensity of the beam 115.

It is therefore possible to light up the phosphor plate 113 with the beam 115 such as to form on this plate 113 an image, this image being formed from a succession of lines each formed from a succession of dots which are luminous to a greater or lesser extent, in the same manner as an image on a television screen.

The intensity modulation can be carried out continuously, with the intensity increasing or decreasing continuously between a minimum value and a maximum value. It can also be carried out in a discrete manner, with the intensity jumping from one value to another, between a minimum value and a maximum value. In both cases, it will be possible for the minimum value to be zero, corresponding to an absence of light.

Each point of the phosphor plate 113 thus lit by the beam 115 emits white light 116, with an intensity that is a direct function of the intensity of the beam which lights this point, the emission occurring as per a Lambertian emission diagram.

The phosphor plate 113 can then be considered as a secondary radiation source, made up of a light image, the imaging optical system 114 of which forms an image at infinity, for example on a screen placed at distance in the axis of the optical system 114 and perpendicular to this axis. The image on such a screen is the materialization of the light beam emitted by the optical system 114.

Thus, the beam 117 forms an automotive vehicle lighting beam which is adaptive, i.e. the light power of which can be controlled point-by-point such as to be adapted to the environment of the vehicle.

1. A scanned light beam video projection system, comprising:
a device for emitting a light beam modulated by a video signal, and scanning means suitable for deflecting said light beam in order to allow a video image to be formed,
the emitting device comprising at least two separate light sources each emitting a light sub-beam of substantially linear polarization, which polarization is separate from the other, and a recombining device configured to form said light beam by combining the two light sub-beams, in the direction of the scanning means.

2. The projection system as claimed in claim 1, wherein the recombining device is a recombining prism.

3. The projection system as claimed in the preceding claim 2, wherein the recombining prism is one of the following prisms: Wollaston prism, Glan-Taylor prism, Glan-Thompson prism, and Nicol prism.

4. The projection system as claimed in claim 1, wherein the two light sub-beams have a polarization that is perpendicular to one another.

5. The projection system as claimed in claim 1, wherein the light sources are laser sources.

6. The projection system as claimed in claim 5, wherein the laser sources have power frequency spectrums that are different in a same narrow frequency band.

7. The projection system as claimed in claim 1, wherein the light sub-beams are polychromatic sub-beams and in that the light sources are polychromatic sources.

8. The projection system as claimed in claim 7, wherein each polychromatic light source comprises three monochromatic light sources, a red source emitting a red light beam, a green source emitting a green light beam and a blue source emitting a blue light beam, the red, green and blue beams being combined to form each polychromatic sub-beam.

9. A head-up display, comprising a projection system as claimed in claim 1.

10. An automotive vehicle adaptive lighting device, comprising a projection system as claimed in claim 1.

11. The lighting device as claimed in claim 10, further comprising a wavelength converting device on which an image is formed by the projection system, the converting device emitting a lighting light beam modulated according to said image.

12. A scanned light beam video projection method, comprising:
emitting a light beam modulated by a video signal;
deflecting said light beam by scanning in order to allow the formation of a video image; and
prior to emitting the light beam, combining two separate light sub-beams of substantially linear polarization, which polarizations are separate from one another, in order to form said light beam.
